(19) United States
(12) Patent Application Publication
(10) Pub. No.: US 2004/0146751 A1
(43) Pub. Date: Jul. 29, 2004

(54) Preparation of novel physical transfer elements such as hot stamping foil and methods for using the same in producing chemically resistant bonds

(76) Inventor: Peter Cueli, Hillsborough, NJ (US)

Correspondence Address: RALPH T. LILORE, 371 FRANKLIN AVENUE, THIRD FLOOR - PO BOX 570, NUTLEY, NJ, 07110, US

(21) Appl. No.: 10/761,016

(22) Filed: Jan. 20, 2004

Related U.S. Application Data
(63) Continuation-in-part of application No. 10/350,372, filed on Jan. 23, 2003.

(51) Int. Cl. B05D 1/36; B05D 3/06

(52) U.S. Cl. 428/694 SL; 427/558; 427/551; 427/553; 427/402

(57) ABSTRACT

A technique is disclosed for transferring information from a hot stamping foil or other physical transfer elements to a substrate wherein the adhesive used to attach the information to the substrate is a solid, radiation-curable resin which is cured by radiation to form a tenaciously adhered bond between the substrate and the information transferred. The resulting bond is resistant to solvents, chemicals, detergents, heat and mechanical stresses likely to be encountered in the use of substrates.

Disclosed are different substrates to be used as the base material to which the information is to be transferred such as polyvinylchloride, polyesters and/or paper-based products such as heavy cardboard. The physical transfer elements, e.g. laminates, total transfer films or hot stamping foils, contain the information to be transferred such as colors, metallic films, high refractive index materials, clear coats, adhesive coats, holographic images, lettering, pictures, artwork, and the like.

The process involves transfer of the information via a variety of means such as by hot stamping, or by rolling appropriate physical transfer elements such as laminates and total transfer film which contain the solid, radiation-curable resin, and the information to be transferred onto a suitable substrate under conditions of temperature and pressure and radiation sufficient to transfer the information and cure the resin. The radiation used for curing the resin is ultraviolet light or electron beam radiation.

### CROSS REFERENCE TO RELATED APPLICATIONS

This is a continuation-in-part of U.S. Ser. No. 10/350,372 filed Jan. 23, 2003.

### STATEMENT REGARDING FEDERALLY SPONSORED RESEARCH OR DEVELOPMENT (NOT APPLICABLE)

### REFERENCE TO A “SEQUENCE LISTING”, A TABLE, OR A COMPUTER PROGRAM LISTING APPENDIX SUBMITTED ON A COMPACT DISC (NOT APPLICABLE)

### BACKGROUND OF INVENTION

1. Field of Invention

This invention relates to the technical field of the physical transfer of information such as images, text, and decorative materials to a suitable substrate such as paper, plastic and the like, such as is found in laminates, total transfer structures, and hot stamping foils and the use thereof in transferring information to substrates. More particularly, it relates to a novel method of preparing novel physical transfer structures such as laminates, total transfer structures, and hot stamping foils (also known as transfer foils) which, when bonded to the surfaces of substrates, yields bonding interfaces which are very resistant to chemical attacks such as in laundering and dry-cleaning, mechanical forces, such as stress, wear and tear, and ageing, and to varying environmental conditions such as extremes of temperature, and hot and cold water.

2. Description of Related Art

Materials for physically transferring information from one entity to a substrate are well-known in the art. They are generally multilayered or laminated structures, the layers of which reflect the function needed to achieve a certain result on the substrate to which the information is to be transferred. They are generically termed herein as “physical transfer elements” or information-bearing multilayer structures and they include hot stamping foils, total transfer structures or films, and laminates among others. In addition to the information to be transferred to an underlying substrate, these products generally comprise a carrier or foil layer (sometimes called herein “carrier” or “foil” layer), an optional release layer to facilitate the transfer or release of the information from the carrier before or after the transfer, and an adhesive backing. In some cases, the information to be transferred may be involved in and be part of the carrier layer. There may optionally be other layers depending upon the information being transferred and the ultimate use of the substrate. In hot stamping foils and in many other multilayered or laminated structures, the adhesive backing is a thermoplastic adhesive which is activated by heat to attach the structure containing the information to be transferred to the appropriate substrate. In other physical transfer elements, the adhesive may be a wet adhesive, especially in total transfer structures or films.

Physical transfer elements are very versatile materials which have come into widespread, well-established use in transferring information from a carrier to a desired substrate. The term “information” is used herein as a generic term for describing what is being transferred or desired to be transferred from the physical transfer element to the substrate of interest. The substrate is virtually any vehicle or medium desired to carry the information. The articles resulting from the transfer of the information to the substrate are many and varied. Illustrative of such articles are book covers, wrapping paper, record jackets, tee shirts, driver's licenses, documents intended to be protected against forgery, counterfeiting and the like such as stock certificates, currency, bank notes, passports, travelers checks, credit cards, identity cards, verification cards, leather, natural and synthetic fabric, paper, cardboard, bottles, cans, packaging, boxes, objects of art, and innumerable other articles which can be used to receive a transferred image or information whether it be decorative or the type that is hard to duplicate and therefore is used as a security device, substrates wherein preprinted information or decorative items are desired, and the like.

Examples of types of information which are transferred in art-known procedures and which are useful in the present invention include holographic images, diffractive gratings, clear coating layers, adhesive layers, high refractive index layers; decorative elements, such as artwork; metallic particles and metal surfaces such as are obtained by the transfer of metal particles or vacuum deposited metal layers to a substrate; preprinted text, colors, lettering, pictures, scenes, and the like. The layers may carry other specific materials to be transferred or may lack such materials leaving the layer itself as the information to be transferred. Printing may be made on any layer at anytime.

The particular physical transfer element used as the carrier of information to be transferred lies within the discretion of the manufacturer generally in consideration of which type of element is more suitable for the end use of the transferred information product. Thus, some uses- benefit from hot stamping foil as the source while for others either a laminate procedure or the total transfer procedure would be preferred.

The following description uses hot stamping foil as the basis for explanation since that technique has all of the features of the other methods and an understanding of that technique will facilitate an understanding of the others.

With respect to hot stamping foils, while specific layers employed may vary, a typical structure is represented by the drawing 21 shown in FIG. 3. The first (uppermost) layer 22 is the foil which acts as the carrier for the entire structure. This layer may ultimately be peeled away from the substrate to which the foil structure is to be attached as will be seen below or it may remain as a protective coating for the information being transferred.

When release of the carrier is desired, it is facilitated by a release coat as a second layer 23 between the foil layer 22 and the third layer 24. The third layer 24 is often the layer which either alone or in combination with a fourth layer 25 may be transferred. The third layer 24 is often a clear coat or a lacquer coat, in which case the information being transferred is the layer itself, or a coating containing printed material, in which case the information is the coat containing the printed material. In the former case, the printing can be done or performed after the coat has been transferred. The fourth layer 25 in this description is a metal layer that has been deposited on the lacquer coat 24. The third and fourth layers 24 and 25 make up the information that will be transferred in this presently described instance. In practice, however, there may be more or less layers depending upon the information desired to be transferred and the particular preferences of the fabricator. For example, the release coat 23 may be dispensed with when it is desired to retain the carrier layer 22 for whatever reason or even when it is desired to release a carrier 22 which is not adhered to an underlying clear coat 24. Thus, the term “hot stamping foil” as used herein is meant to apply to a system whether it be in the prior art or in the description of the instant invention, which comprises information to be transferred to a substrate and an adhesive layer for attaching that information to the substrate.

As the adhesive layer, there is the final layer 25a) which constitutes the means by which the entire foil structure 21 is attached to the substrate intended for use (not shown in FIG. 3) and is common to virtually all hot stamping foils. In other physical transfer elements, other adhesives such as wet adhesives are often used. In particular, the adhesive used as the attachment layer 25a) to the substrate in the prior art is a thermoplastic, heat-sensitive adhesive that is activated when heat is applied to the adhesive and the substrate to which the hot stamping foil will be bonded. It is in the nature of the adhesive layer of the physical transfer element, whether it be a hot stamping foil, a laminate, a total transfer structure or other form, that the present invention is centered.

In practice, the hot stamping foil is prepared by applying the relevant layers of material sequentially to the carrier layer. In a typical case, the process is a continuous one using rolls of foil and standard coating techniques with each layer being built upon the previous one in sequence. Those skilled in the art are well aware of the materials to be used and how these materials are prepared and applied. Briefly, however, the procedure involves first coating rolls of the appropriate carrier membrane, such as a web of a polyester, mylar, cellulose acetate, or other similar material capable of acting as the support for the rest of the layers and capable of being released (when release is desired) with a release coating. This coating will facilitate the release of the foil from the structure after the structure is attached to the substrate. Next, the desired layers are applied depending on the nature of the product to be transferred. For example, in some cases, it may be desired to transfer a holographic image. In such a case, the next layer deposited could be an embossable medium such as a suitable lacquer. This layer may then be metallized in which case it is often formed as an additional layer. The holographic image may be embossed either before the metal layer is applied, which is preferred, or after the metal layer is deposited.

When embossing is not used, for example when only a color or decorative image is desired, the metal layer can be dispensed with or it may be applied as desired. In any event, and irrespective of what information is to be transferred, a layer or complex of layers is deposited which satisfies the needs of the transfer process and the protection of the ultimate substrate either for security reasons or to protect the transferred material from wear and tear.

Finally, the thermoplastic, heat-sensitive adhesive needed to bond the information to the substrate is applied to the multilayered structure to yield the final hot stamping foil product. Next, the hot stamping foil structure is applied to the desired substrate under heat and pressure to transfer the information to that substrate. The foil layer may be peeled away from the final transferred product as and when desired if a release layer has been used. In some cases, the foil may not adhere well to a clear coat and thus is peelable therefrom even without a release coat. In other cases, the foil may adhere well to the underlying clear coat in the absence of a release coat and thus may act as a protective coat. In practice, the hot stamping foil is generally manufactured in the form of a roll of material containing the successive attachments of the layers previously described with the last layer being the heat-sensitive adhesive layer which will be the basis for the attachment to the substrate of interest.

The hot stamping foil with the adhesive on it may be used for further manufacturing by the producer or sold to a fabricator. In the latter case, the fabricator will transfer the information to the substrate of interest by contacting the foil structure with the substrate, applying heat and pressure to the combined foil/substrate structure, allowing the heated adhesive to cool and then optionally removing the foil itself leaving only the information on the substrate. There may be protective coatings applied to the material transferred so that there is no or little danger of disturbing the integrity of the material transferred to the substrate or as stated previously, the carrier layer may be left in place to act in that capacity. Any printing required on the substrate usually may be applied before or after the hot foil stamping step.

All of the foregoing are steps well-known in the art and easily practiced by the skilled artisan.

The present invention relies on the nature of the adhesive used in the foregoing discussion. More particularly, the use in the prior art of heat-sensitive, thermoplastic adhesives as the final layer of the hot stamping foil, or other adhesives in the case of other physical transfer elements, results in major disadvantages in the bond produced on the substrate in that the adhesive properties possessed by the bond are not permanent and are subject to attack and degradation by the environment or other adverse conditions when put to use. The bond obtained from the art-used adhesive is subject to deterioration and even reversal by a number of different events or actions. For example, if the article comes into contact with heat, it is very likely that the transferred information could be released, displaced, dislodged, or disoriented on the final substrate. In other areas, because the chemical nature of the adhesive has not been changed, the bond itself is subject to alteration and possibly even destruction by chemical action from such things as dry-cleaning fluids, washing detergents, by laundering, or by a variety of other potential chemical attacks. Moreover, the bond is often not satisfactorily resistant to certain mechanical stresses. These chemical and mechanical deficiencies, while tolerable for some uses of substrates, are not tolerable when the ultimate product will likely come into contact with these conditions. For example, as previously noted, currencies require very stringent chemical resistance specifications as do articles of clothing that must be washed or dry-cleaned. For example, when it is desired to attach security or anti-counterfeiting images to currency, the bond must resist constant use and wear and tear and be able to stand up to inadvertent contacts with solvents, washings, dry-cleaning, exposure to salt water, and the like. In fact, currency use generally requires that detailed stringent specifications be met by the ultimately produced currency. It is well-known that currencies produced with anti-forging or anti-counterfeiting images, especially holograms, do not meet these stringent specifications. Consider also when clothing is to be treated with a decorative transfer, the resulting bond on the product must be able to withstand hot water, laundry detergents, dry-cleaning fluids, stain removers, extremes of hot and cold ambient temperatures, mechanical resistance, wear and tear, folding, wrinkling, ageing, and a variety of other conditions and other effects too numerous to mention. The bond must be strong enough during even normal and stressful conditions to retain its integrity. Laminates and total transfer structures or films suffer from similar disadvantages.

The present inventor has discovered, however, that when the physical transfer element is provided with a solid, radiation-curable resin as the final layer and applied to an information-receiving surface of a desired substrate under heat and pressure and then subjected to the radiation necessary to cure the resin, the cured resin bonds the substrate to the transferred information in an extremely tenacious, durable bond which is resistant to chemical and environmental conditions. The radiation to cure the resin is usually ultraviolet or electron beam radiation.

Radiation-curable resins may readily be found in the art and in fact are used in various stages of the fabrication process of information transfer to the substrate. We have not found any method of using solid, radiation-cured resins to produce the products claimed herein having the highly desirable properties of chemical and environmental resistance possessed by such a bond when so used. Such a set of characteristics is extremely important when ultimately the substrate can be expected to be subjected, both wittingly and unwittingly, to extremes of conditions and, therefore, must be extremely resistant to such conditions.

No prior art has been found wherein a physical transfer element employs a solid, radiation-curable resin as the adhesive layer. Nor has any prior art been found wherein transferred information on a substrate is anchored by a solid, radiation-cured resin obtained from a physical transfer element containing, as its adhesive layer, a solid, radiation-curable resin.

### BRIEF SUMMARY OF THE INVENTION

The present invention contemplates both a novel physical transfer element production method and a novel physical transfer element produced by that method. The method is useful for any physical transfer element containing information to be transferred to any substrate. In its broadest sense, the invention contemplates preparing a physical transfer element or, as it is also termed herein, an information-bearing multilayer structure, having an adhesive layer of a solid, radiation-curable resin. In its simplest application, the physical transfer element can comprise as little as two layers, i.e. the carrier layer and the solid layer of radiation-curable resin. In such a case, the information to be transferred may comprise the solid layer of radiation-curable resin itself or the carrier with the resin layer. Either or both of these layers may also comprise other information desired to be transferred such as metal particles, printed text and the like. Printed material may be positioned in reverse on the exposed underside of the solid layer and transferred to the substrate. The resulting product is novel. It should go without saying that any information provided on the underside of the adhesive layer destined to come into contact with the substrate, should not cover so much of the adhesive as to materially affect achieving the tenacious and chemically resistant properties of the resulting bond to the substrate. Significantly, applying printing in reverse to the underside of the curable resin, is a preferred manner of transferring such information to a substrate, and is not available in the prior art use of wet resin adhesive layers.

Information such as particles or printed material may also be positioned on top of the carrier layer to which the adhesive layer is attached and transferred via the adhesive to a substrate. In the latter case, any information printed on the carrier would remain on the carrier and in most cases under this embodiment, the carrier would not be removed from the substrate. Information desired on the substrate in the ultimate product may also be printed on the substrate itself with the adhesive layer being transferred directly onto the printed substrate for protection. Even in this application, the foil or the carrier layer may be removable or not depending on the nature of the article, whether there is additional protection desired on the cured resin layer, or whether it is suitable for the cured resin layer on top of the substrate to be the only source of protection for the information printed on the substrate.

The preferred physical transfer element of the present invention is a hot stamping foil, but it is to be understood that this term applies as well to any information-bearing entity which comprises information to be transferred from one source to a substrate including specifically, total transfer film and laminates. As noted previously in connection with the description of the prior art, the term “information” is used in the description of the invention as a generic term for describing the material being transferred or desired to be transferred from the physical transfer element to the substrate of interest. Thus, it may take a variety of forms such as information which is transferred in art-known procedures. The term “information” as used in the present invention comprises any material desired to be transferred including holographic images, diffractive gratings, clear coating layers, adhesive layers, high refractive index layers; decorative elements, such as artwork; metallic particles and metal surfaces such as are obtained by the transfer or metal particles or vacuum deposited metal layers to a substrate; preprinted text, colors, lettering, pictures, scenes, and the like. The layers, for example, the solid radiation-curable resin, may or may not carry any other specific material to be transferred. Usually, printing may be made on any layer.

The invention may be used in numerous applications. For example, the transfer of a solid radiation-curable resin to a substrate with subsequent radiation curing of the resin results in a tenacious bond between the resin and the substrate. The bond also resists chemical and mechanical attack to a far greater extent than does the conventional thermoplastic adhesive which would normally be used on the substrate to attach information.

The protection offered by the tenacious and resistant interface to information present on (or transferred to) the final product such as in passports, currency, and the like is very substantial and not previously obtainable in the prior art. The advantages thus obtained are apparent virtually irrespective of where the information is placed in the physical transfer element. In this regard, many alternatives are possible. For example, if textual material such as printing is desired, that material may be positioned on the substrate itself and the physical transfer element used to transfer the radiation-curable resin adhesive to that surface. This would be followed by radiation curing of the solid resin layer. Depending on the architecture of the physical transfer element, the carrier may remain in place or be peelable away to expose the cured resin layer as a protective adhesive layer on the substrate.

The physical transfer elements of the invention may have any number of structural configurations and architectures depending upon the use to which the physical transfer element will be put, the desires of the final user, and the requirements of the final product. A common characteristic is that the physical transfer element is a multi-layered structure or composite which comprises a carrier layer attached either directly to a layer comprising a solid radiation-curable resin or attached indirectly via an intermediate layer or layers to a layer comprising a solid radiation-curable resin. Such a composite may be represented by a physical transfer element comprising information to be transferred to a substrate having the following architecture:

1. A carrier, polyester for example,

2. Optionally, a release coat which facilitates removal of the carrier layer when and if desired,

3. A layer of the solid radiation-curable resin.

In such a configuration, if there is no further information provided to the physical transfer element, then the layer of solid radiation-curable resin itself is, in effect, the information to be transferred to a substrate. On the other hand, information can be provided to the physical transfer element virtually at any point in the composite. Whether or not the physical transfer element remains as originally configured with the carrier depends upon the desires of the user, the manufacturer, and the particular product produced. If the composite contains a release coat in anticipation of such release, then the material will be releasable. On the other hand, there are carriers which do not need release coats and may be peelable away because of the lack of strong adherence to the solid radiation-curable resin.

The carrier for the physical transfer element may be any sheeting material used or useable by the art as a carrier material or protective layer. Usually polypropylene or a polyester (polyethylene terephthalate) is employed with the latter being preferred.

A suitable architecture for the various layers of a hot stamping foil of the present invention comprises as the following:

1. carrier or foil layer, polyester for example,

2. optionally, a release coat which facilitates removal of the foil layer when desired,

3. a coating, and

4. a layer of a solid, radiation-curable resin

wherein any one or more of the foregoing layers may be or otherwise comprise the information desired to be transferred.

When metallics or high refractive index materials, with or without holograms, are used, a suitable architecture comprises the following:

1. polyester carrier layer,

2. optional release coat,

3. a clear coating which may or may not comprise information to be transferred, or an embossed coating for a hologram,

4. a layer of metallic or high refractive index material, and

5. a layer of solid, radiation-curable resin.

A suitable architecture for a total transfer film comprises the following:

1. polyester film

2. urethane release coat

3. vacuum deposited metallized layer

4. layer of solid, radiation-curable resin

In the prior art, layer 4 of the total transfer film is typically a wet adhesive.

The hot stamping foil and other physical transfer elements of the present invention are preferably manufactured in a manner which utilizes known processes for applying the various layers desired by the manufacturer and the results intended for the ultimate attachment to a desired substrate as adapted for the application of the solid, radiation-curable layer. Whatever other properties that layer has, it is critical to the present invention that it be a solid, radiation-curable resin. Thus, the layer could even be a heat-sensitive adhesive in its own right and, in fact, for some procedures and processes, this is preferred in the product of the present invention. The method of the present invention, applied to hot stamping foil, thus comprises preparing a hot stamping foil structure wherein the adhesive layer is a solid, radiation-curable resin applied to the last layer in a manner which results in a relatively uniform layer of the solid, radiation-curable resin. For example, the solid may be applied in the form of an emulsion or as a hot melt, or as a solution of the solid resin in a suitable solvent. Application as a solution of the solid resin in a suitable solvent is preferred. Thus, the final hot stamping foil contains the structures that one desires or needs in the hot stamping foil, except that the final layer, the layer to be used as the attaching layer to the substrate, is a radiation-curable resin derived from a solid resin. As noted above, the present invention does not exclude the use of a heat-sensitive, resin because some solid, radiation-curable resins also are heat-sensitive, thermoplastic adhesives in addition to being radiation-curable. Similarly, as stated previously, the above descriptions of the hot stamping foil as the multi-layer structure, and the descriptions which follow, are illustrative only, it being understood that the process is equally applicable to any other physical transfer element modified in accordance with the present invention.

Carrier Layer

As carrier layers, basically any sheeting material used in the art may be employed such as polypropylene or some other polyester such as polyethylene terephthalate, which is usually preferred, or papers of various kinds. Release papers, silicone papers, and wax papers may also be used when it is desired to remove the carrier layer at some point. The carrier layer may also contain the information to be transferred.

Release Layer

The release coatings are also known in the art and may be any release coat that is consistent with the subsequent treatment of the hot stamping foil after it has been applied to the substrate and is, therefore, consistent with the use of radiation to cure the resin. A variety of known release layers may be used. Waxes are very frequently employed as the release layer.

Information to be Transferred

The content of the layer (or layers) of information to be transferred is as wide and as varied as may be desired, especially those encountered in the prior art of hot stamping foil and the physical transfer element fields since the essence of the invention is not that which is transferred to the substrate, but rather how the information that is transferred is attached to the substrate. Mention has been made previously herein of numerous such types of information. The information being transferred may be part of the carrier or clear coat or embossable coat when used. The clear coat may be any such coat used in the art, typically urethanes or acrylics, and may contain color, metal particles, metal deposits and the like. The embossable coat may contain embossed information to be transferred. The solid radiation-curable adhesive layer itself may constitute the information to be transferred whether or not additional information is contained therein or thereon.

Of course, one should take note that if the radiation used is ultraviolet light, then the layers used to transmit that light should be transparent to ultraviolet light. If electron beam radiation is used, then, of course, only layers which pass electron beams should be used in the path of the curing beam.

Solid, Radiation-Curable Resin

The layer of radiation-curable resin is a solid, applied using standard techniques. As the solid, radiation-curable resins which may be selected, those which are solid at room temperature, but have a melting or softening point in the region of the usual hot stamping transfer temperature range, in the range of between 100° F. to 350° F. are suitable for use herein with those in the range of 140° F. to 300° F. being preferred. Any solid resin which is radiation-curable is suitable, but the practicality of the industry-utilized procedures suggests that the most conveniently employed ones will be resins melting in the hot-stamping foil utilization temperature. While the ultimate objects of the invention are obtained via the later cure of the resin by radiation, there is a component of adhesion that may be obtained during the hot stamping process and thus those resins which are also heat-sensitive resins will be preferred notwithstanding that it is the ultimate and indispensable curing of the resin by radiation sufficient to effect a cure which causes a durable, tenacious, inert, resistant bond having the advantages heretofore described, to be formed.

Virtually any solid resin which is radiation-curable may be used in the invention. Readily available are low-melting, solid, radiation-curable resins which are curable using a suitable catalyst such as a photoinitiator in the case of UV curable resins, or in the case of electron beam radiation, curable with or without a photoinitiator. Thus, any such resins, including the heat-sensitive resins known in the art to be hot stamping adhesives, may be used in the invention if they contain functional groups which can be cured by radiation. Resins containing epoxy groups or vinyl groups as the functional groups are suitable for use as resins in this invention and those with epoxy groups are readily available. Many of these are available from Dow Chemical Company of Midland, Mich. such as those designated as DER 661, Araldite GT 7071, Epi-Rez 520-C, Epon 1001-F, Epotuf 37-001, Araldite GZ 465 A-80, Araldite LZ 8001 A-80 SP, Araldite LZ 8003 A-80 SP, Epon 836-A-85, Epon 1001-A-80, Epotuf 38-575, Epotuf 38-580. Solid, radiation-curable resins with vinyl groups are less readily commercially available. If heat-sensitive resins known in the art to be useful as hot stamping adhesives do not contain functional groups sufficient to render the solid, radiation-curable resins curable, they may be modified by techniques known in the art to include such groups to render them useable in the present invention.

For application to the hot stamping foils or other physical transfer elements, the resins may be dissolved in a suitable solvent such as organic solvents typified by ketones such as methyl ethyl ketone, acetone, methyl isobutyl ketone; other organic solvents such as xylene, toluene, and esters such as alkyl acetates including ethyl acetate, propyl, butyl, and pentyl acetates, and the like. They may also be applied as water emulsions or as hot melts.

### DESCRIPTION OF DRAWINGS AND DETAILED DESCRIPTION OF THE INVENTION

FIG. 1 is a representation of a continuous flow process for carrying out the method of the present invention.

FIG. 2 is a depiction of the architecture of one embodiment of the hot stamping foil of the present invention and which may be used in the process of FIG. 1.

FIG. 3 is a depiction of the architecture of a typical hot stamping foil of the prior art.

FIG. 4 shows a substrate prepared according to the process of the present invention.

FIG. 5 shows the architecture of another embodiment of the present invention.

FIG. 6 shows the architecture of yet another embodiment of the present invention.

FIG. 7 shows the architecture of a substrate using the embodiment of FIG. 5.

FIG. 8 shows the architecture of a substrate using the embodiment of FIG. 6.

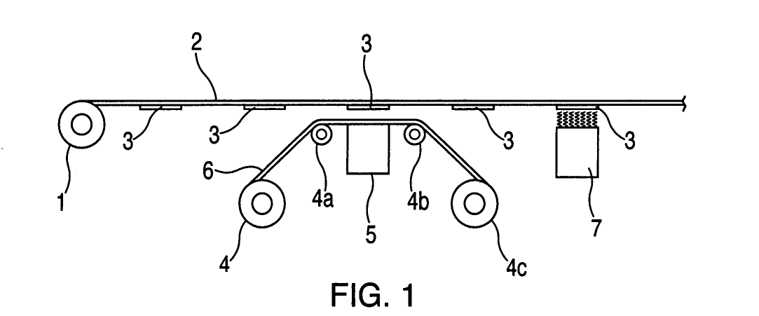

Turning now to FIG. 1, there is shown therein a continuous process for using a hot stamping foil of the present invention on, for illustrative purposes, blank United States or Euro currency paper as the substrate. Roller 1 contains a roll of backing material 2 on which are carried the blank currency paper sheets upon which the appropriate text and anti-forging and anti-counterfeiting information can be applied. The process of the invention is sufficiently flexible to allow either the preprinting of the currency or the placement of the security information upon the substrate before printing, which is the preferred mode of practicing the invention. Roll 4 contains a continuous hot stamping foil 6 comprising information to be transferred (not shown in FIG. 1) to paper sheet 3 and a polyester carrier transported over rollers 4a and 4b and taken up at 4c. Thermal transfer head 5 is set opposite backing material 2 such that when the opposing faces of a sheet 3 and thermal head 5 are opposite each other, the thermal head is actuated with sufficient heat and pressure to transfer the information together with a layer of a solid, radiation-curable resin from hot stamping foil 6 to the blank currency paper. Thereafter, the treated currency paper substrate 3 proceeds to a radiation station 7 where a source of radiation impinges upon the radiation-curable resin (not shown in FIG. 1) now attached to the blank substrate 3 using an intensity and time sufficient to cure said resin into the strong durable, chemically resistant bond.

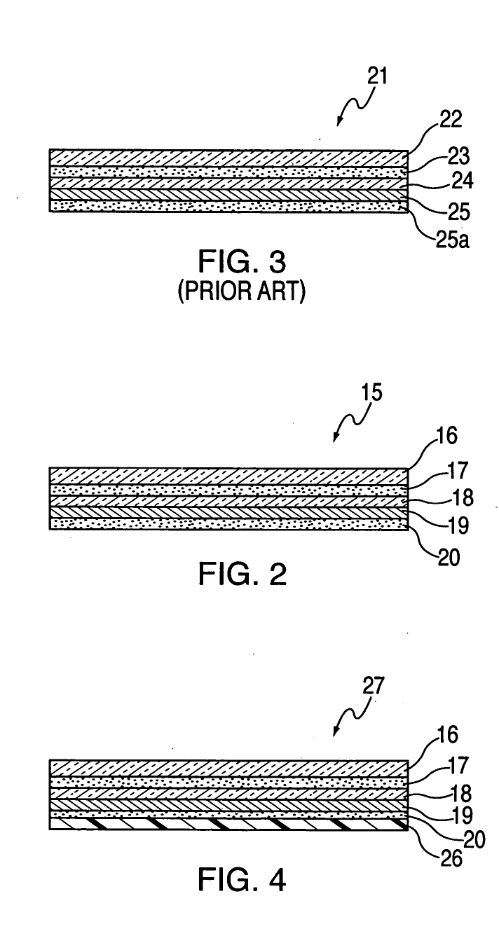

FIG. 2 shows the architecture of one embodiment of a hot stamping foil which is useable in the process of the invention to transfer information to a substrate wherein the information comprises embossed coatings or metallic or holographic materials to be transferred. Reference to FIG. 2 shows the following:

Shown is an elevation view 15 in greatly exaggerated scale of a hot stamping foil which will be used to transfer the embossed coating or metallic or other holographic images to a substrate. The polyester foil backing material 16 is treated with a release coat 17 which will facilitate the release and separation of embossed coat 18 and metallic coat 19 from the polyester layer 16. The release coat 17 may be any normally used in the art which remains on the carrier and can be individually selected by one skilled in the art. Such materials as organosilicones, silicone polymers, siloxanes, and waxes from aliphatic hydrocarbons with a low melting point are normally suitable. Attached to the release coat is information layers 18 and 19. Adjacent to coat 19 is the layer 20 of the solid, radiation-curable resin which will serve to cause the information from 18 and 19, once hot stamped from the hot stamping foil to the substrate 26 (FIG. 4), and cured via exposure to radiation, to adhere tenaciously to the substrate 26 with the advantages of chemical and mechanical resistance hereinabove described (substrate not shown in FIG. 2).

FIG. 3 demonstrates the architecture of a type of hot stamping foil 21 of the prior art. Layer 22 is the polyester carrier layer and layer 23 is the release coat as set forth for 16 and 17, respectively in FIG. 2. Layers 24 and 25 may themselves be the metallic or holographic images with different images superimposed upon the others. They are then covered by the thermoplastic, heat-sensitive adhesive 25a) of the prior art.

Once the appropriate image or images are transferred from the hot stamping foil represented by FIG. 2 to a substrate and the composite subjected to the radiation cure as described in FIG. 1, the composite 27 as shown in FIG. 4 is obtained. Thus, FIG. 4 shows the result of the transfer of layers 18 and 19 from FIG. 2 to the substrate 26. Polyester carrier layer 16 may be peeled back from structure 27 facilitated by the release coat 17.

In another embodiment, release coat 17 may be omitted (not shown in FIG. 2) in which case the carrier backing material 16 is bound directly to the information layers 18 and 19 to act as a protective coating for such information.

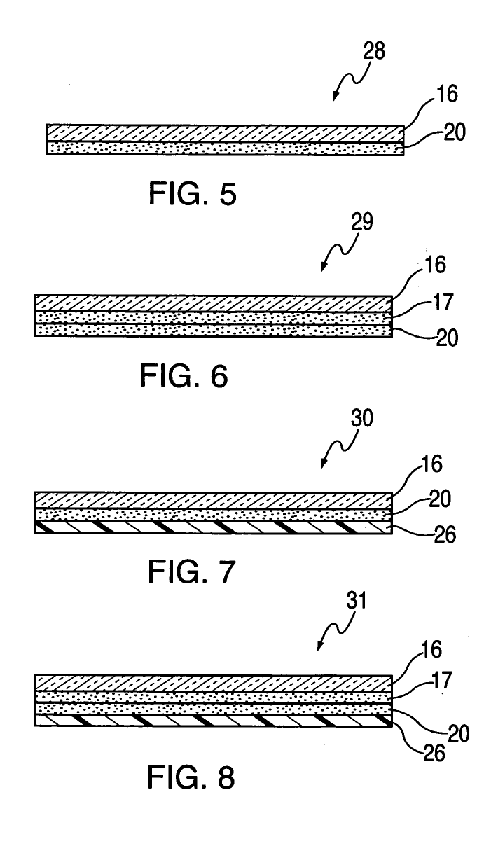

In still another embodiment of the invention, FIG. 5 shows a physical transfer element 28 without a release coat 17 and without information layers 18 and 19, and wherein layer 20, the solid radiation-curable resin, attached directly to polyester layer 16, constitutes the information to be transferred to a substrate 26 (see FIG. 7).

In yet another embodiment of the invention, FIG. 6 shows a physical transfer element 29 having a release coat 17 interspersed between carrier 16 and solid radiation-curable layer 20. This embodiment shows no additional information layers 18 and 19. Thus, layer 20 constitutes the information to be transferred to a substrate 26 (see FIG. 7). The use of this embodiment of the invention described in FIG. 6 will permit, where, desired the release and peel back of carrier 16 after application of the physical transfer element 29 to substrate 26 as shown in FIG. 6.

In utilization of the embodiments shown in FIGS. 5 and 6, if desired, additional information can be presented on the underside of layer 20. This can be in the form of printing of text material or a layer of particles or some such information desired to be transferred to some substrate 26.

FIG. 7 shows the result of applying the physical transfer element of FIG. 5 using the process described above to substrate 26. In such a case, as noted previously, the information transferred may be the radiation-curable adhesive layer 20 itself, as shown in FIG. 5 and as described above, or it may either be printed on the underside of layer 20 or may be applied to a substrate which itself has printing or other material thereon, such as security or anti-counterfeiting information. Of course, when these embodiments are chosen and the underlying material must be visible, then the coatings should be “see-through” coatings so that the images that are placed either on the underside of the layer or on the substrate itself are visible after the curing operation.

FIG. 8 shows the composite 31 obtained when the structure of FIG. 6 having a release coat is transferred to substrate 26.

The process of producing hot stamping foils and other specific physical transfer elements is so well-known in the art that any skilled artisan in the field is well aware of how to produce such materials. Thus, in order to produce the products of the invention, one utilizes the art-known methods modified by the teachings of the invention relating to the use of the solid, radiation-curable resin. Specifically, one

a) provides an information-bearing multilayer structure or composite, preferably a hot stamping foil, comprising

i) a suitable carrier layer,

ii) information to be transferred to an information-receiving surface of a substrate, and

iii) a layer comprising a solid, radiation-curable resin attached directly, or indirectly via an intermediate layer, to said substrate,

b) provides a substrate having an information-receiving surface to which it is desired to transfer said information,

c) contacts said information-receiving surface of said substrate with said layer comprising said solid, radiation-curable resin under conditions of temperature and pressure sufficient to transfer said information from said information-bearing multilayer structure, preferably said hot stamping foil, to said information-receiving surface, and

d) subjects the radiation-curable resin to sufficient radiation to effect a cure thereof and thereby cause said information to be bonded to said information-receiving surface.

If desired, the information to be transferred set forth in step a)ii) comprises the layer comprising the solid, radiation-curable resin set forth in a)iii).

Such a structure would be supplied with all the layers desired by the fabricator prior to the application of the final solid resin layer including, of course, the layer or layers of information desired to be transferred. Such information may also be incorporated into and be part of the carrier layer in some cases. In the latter case, the structure could have as little as two layers, i.e. the carrier with information carried therein and the solid, resin-curable layer. The structure is also provided with an appropriate solid, radiation-curable resin followed by a drying of the resin solution or emulsion layer when either is employed or by cooling a hot melt when employed, to a solid layer, thus yielding the novel products, preferably hot stamping foils, of the present invention. There may be any number and type of layers applied in the structure, determined by the desires of the fabricator, requirements of the ultimate user, and the like. Thus, it may be said that each layer could be considered to be attached either directly to a given layer or indirectly to that layer via intermediate layers.

Radiation-Curable Resins

The resins employed may be any of those to which reference has previously been made herein and the preferred ones are epoxy resins preferably having a low melting point, that is, one within the range normally encountered in the application of hot stamping foils to substrates, usually of the order of 100° F. to 350° F. and most preferably of the order of 140° F. to 300° F.

Photoinitiator

Usually, when curing with UV rather than electron beam radiation, it is desirable to add a photoinitiator which catalyzes the polymerization of the resin. If electron beam radiation is used, a photoinitiator is usually not necessary. There are generally two types of photoinitiators: free radical and cationic. If cationically curable resins are used in the compositions of the invention, it is desirable to use cationic photoinitiators. Cationic photoinitiators undergo a photochemical transformation upon excitation into a form which initiates cationic polymerization and crosslinking. On the other hand, if the resins of the invention are cured with electron beam, the cationic photoinitiator may not be necessary. Various types of cationic photoinitiators are available and suitable. A suitable photoinitiator for epoxy resins is available from Union Carbide Chemicals and Plastics Company, Danbury, Conn., under the names Cyracure UVR 6110, 6100, 6379, 6351, 6200, and 6990 with the 6990 product being preferred. Ketone- or phenone-based photoinitiators are suitable for curing of resins with vinyl functionality. The particular photoinitiator used is not critical as long as it effects the appropriate cure within the time frame consistent with interests of the fabricator. Photoinitiators are also obtainable from Ciba-Geigy, Hawthorne, N.Y.

Application of the Solid Resin

When a solution of the resin is applied in the manufacturing process, any solvent suitable under the conditions may be employed as a solvent for the resin. Merely as examples, there may be mentioned ketones such as acetone, methyl ethyl ketone, and methyl isobutyl ketone. The concentration of solids in the solution (or emulsion, when used), should be such as to provide a viscosity suitably handled in the preparation process. Concentrations in the range of from 5 to 90% by weight and preferably 10 to 80% by weight are suitable although the actual concentrations will depend largely on the preferences of the manufacturers. Thus, more dilute or more concentrated solutions or emulsions may be employed if suitable in the manufacturing process and the final requirements of the substrate produced.

The thickness of the resin coating when applied as wet is virtually any thickness that is suitable in the process. Suitable thicknesses range between 0.1 microns to 50 microns, and preferably 1 micron to 25 microns yielding a dry thickness of 0.01 microns to 45 microns and preferably of 0.1 microns to 20 microns although different thicknesses may be used, if desired. For a porous substrate such as paper, thicknesses at the higher end of the range may be used and for the less porous substrate such as plastics, thicknesses at the lower end may be more suitable. After the resin is applied, the coating is next dried at temperatures which depend largely on the nature of the solvent or liquid vehicle used in the emulsion and the speed of drying. Temperatures usually in the range of 100° F. to 400° F. effect drying in a suitable time frame. The hot stamping foil with the dried radiation-curable resin layer thus produced is a novel product of this invention. It may be either shipped or may be used directly in the attachment to a suitable substrate.

In use, the product containing the now-dried radiation-curable resin is brought into contact with the information-receiving surface of the substrate by compressing the resin layer against the substrate's surface under sufficient heat and pressure to transfer the information to the substrate. The thus-modified substrate is then subjected to the radiation step to cure the solid resin into a crosslinked, highly inert cured resin bond resulting in the physical transfer element structure being attached firmly and virtually irreversibly to the substrate via the cured resin layer. Depending on the ultimate desires of the user, the foil or carrier may either be retained as a coating on the transferred information (assuming appropriate modification of the release layer and selection of appropriate clear coat) or stripped away from the transferred information, which may then be further modified by additional coatings.

Radiation Cure

The amount and duration of radiation used to effect the cure is of such intensity and for a sufficient period of time to cure the resins to an inert state.

Those skilled in the art will be capable of selecting an intensity of radiation and a time of exposure sufficient to cure the selected resin within the time frame required under the conditions of manufacture. Useful parameters include ultraviolet radiation having a wavelength of 4 to 400 nm, and preferably 325 to 365 nm. Suitable results are obtained when the radiation is either UV light or electron beam radiation for a period of time normally encountered at the continuous roll speeds in hot stamping foil manufacturing. Of course, these parameters are affected by the speed at which a given material passes through the process and those skilled in the art will be able to make adjustments depending on their own situation.

Certain of the products that result from the above-described process are novel. Illustrative of such products are those comprising the following architecture:

1. a carrier material which may or may not be peelable away from the final product,

2. information transferred to a substrate,

3. a layer of a radiation-cured solid resin, which may also comprise the information of component 2, attached to,

4. a suitable substrate.

The above product wherein the information of component 2 comprises printed material on the surface of the layer of radiation-cured solid resin attached to the substrate, is a novel product of the invention.

The bonds of all of the products of the invention at the interface of the cured resin adhesive and the substrate are characterized by having superior resistance to chemical attack and extremes of environmental conditions compared to the prior art structure having the information attached to the substrate via thermoplastic adhesives.

### EXAMPLE 1

A Euro currency note having a hologram attached to it was obtained from the normal Euro circulation system. A small amount of xylene was applied to the hologram from a cotton swap saturated with the xylene and the note allowed to stand for at least thirty seconds. After being in contact with the solvent, the hologram was easily removed from the Euro note by gentle rubbing of the hologram.

### EXAMPLE 2

A hot stamping foil of the present invention comprising a peelable, polyester (terephthalate) carrier layer, a release coat of wax, a metallized urethane or acrylic clear coat containing a holographic image layer to be transferred to a substrate, and a resin layer made from a blend of two resins, one of which is a solid, radiation-curable epoxy resin, was produced as described hereinabove. The blend was made up of 103 grams of a solution of solid, radiation-curable resin DER 661, (50% by weight in methyl ethyl ketone) available from Dow Chemical Company as previously stated, and 125 grams of a solution of Phenoxy PKCP 67 (40% by weight in methyl ethyl ketone) a caprolactam-modified phenoxy resin available from In Chem Inc., Rockhill, S.C., and 3% by weight of a photoinitiator designated Cyracure UVR 6990. The blend of resins was applied as a thin layer to the holographic image layers to be transferred in the manner well-known in the art and as described herein. After drying of the solvents, the hologram was then transferred from the hot stamping foil together with the radiation-curable resin to a blank piece of United States currency paper using a hot stamping machine at the softening point of the blend (approximately 140° F. to 170° F.). The blended resin was then cured to a solid, crosslinked inert state by exposure to UV radiation from a standard UV lamp. Next, the hologram attached to the blank currency paper via the cured resin was immersed in xylene and allowed to stand for fifteen minutes or more. The hologram so treated was subjected to vigorous rubbing, but could not be removed from the currency paper. The hologram remained tenaciously attached to the currency paper well after treatment and remained so attached.

### EXAMPLE 3

The procedure of Example 2 is followed except that the release coat is omitted and an adhesion-promote polyester film carrier selected for its ability to adhere to clear coats of urethanes and acrylics, was used. The carrier remains as a protective coating for the hologram transferred to the blank currency substrate. After curing, the transferred hologram could not be pulled away from the currency by heating or chemical attack without destroying the treated currency papers. The polyester is similarly firmly secured to the currency paper and could not be removed without tearing the currency. To show solvent resistance, the currency paper was immersed in xylene for fifteen minutes or more and submitted to vigorous rubbing after being removed from the solvent as was done in Example 2. The transferred hologram could not be removed from the currency paper without tearing the paper and remained tenaciously attached thereto.

### EXAMPLE 4

The procedure of Example 2 is followed except that in the place of the hot stamping foil, the composite physical transfer element of FIG. 5, comprising the polyester (terephthalate) carrier layer attached directly to the solid, radiation-curable epoxy resin without there being an intermediate release layer, was used. The blend of resins was applied as a thin layer to the carrier layer in the manner well-known in the art and as previously described herein. After drying of the solvents, the radiation-curable resin was transferred using the procedure of Example 2 to a substrate upon which had been printed the data and information usually found on a driver's license. The blended resin was then cured to a solid, crosslinked inert state by exposure to UV radiation from a standard UV lamp. The carrier layer remained as a protective coating on top of the cured resin layer which together were tenaciously attached to the driver's license substrate, and which could not be pulled away from the structure without destroying the underlying driver's license substrate.

### EXAMPLE 5

The process of Example 4 was repeated except that the physical transfer element of FIG. 6 comprising a peelable, polyester (terephthalate) carrier layer attached through a release coat of wax to a solid, radiation-curable epoxy resin, was used instead of the composite desribed in Example 4 lacking the release coat. Prior to the transfer, textual material was printed in reverse on the underside of the solid uncured resin. The composite was transferred as described in Example 2 to a substrate and subjected to the curing step to yield a strongly bonded resin layer onto the substrate with the printed material visible through the cured resin layer. The peelable carrier layer was then peeled away exposing the cured resin as the protective layer for printed material transferred to the substrate.

The foregoing represents various embodiments of the invention which can be varied according to the desires of those skilled in the art without deviating from the scope of the invention.

What is claimed is:

1. A process for transferring information from an information-bearing multilayer structure to a substrate which comprises
a) providing an information-bearing multilayer structure comprising
i) a carrier layer which may or may not be peelable away from the structure,
ii) information desired to be transferred to a substrate, and
iii) a layer comprising a solid, radiation-curable resin,
b) providing a substrate having an information-receiving surface to which it is desired to transfer said information,
c) contacting said information-receiving surface of said substrate with said layer comprising said solid, radiation-curable resin under conditions of temperature and pressure sufficient to transfer said information from said information-bearing multilayer structure to said information-receiving surface, and
d) subjecting the radiation-curable resin to sufficient radiation with or without a photoinitiator to effect a cure thereof and thereby cause said information to be bonded to said information-receiving surface.

2. The process of claim 1 wherein said radiation is ultraviolet radiation or electron beam radiation.

3. The process of claim 2 wherein said radiation-curable resin comprises epoxy group functionality.

4. The process of claim 2 wherein said radiation-curable resin comprises vinyl group functionality.

5. The process of claim 3 wherein the structure comprises a release coat between the carrier and the information to be transferred.

6. The process of claim 3 wherein the structure additionally comprises a clear coat attached to said carrier layer.

7. The process of claim 5 wherein the structure additionally comprises a clear coat between said release coat and said information to be transferred.

8. The process of claim 7 wherein said information to be transferred is either attached to said clear coat or is part of said clear coat.

9. The process of claim 3 wherein the carrier layer is not peelable away from the information to be transferred after step d) is performed.

10. The process of claim 3 wherein the carrier layer is polyester material.

11. The process of claim 10 wherein the polyester material is polyethylene terephthalate.

12. The process of claim 3 wherein the conditions of contacting in step c) to transfer said information include a temperature of between 100° F. and 400° F.

13. The process of claim 12 wherein the substrate is selected from the group consisting of polyvinyl chloride, polyesters, and paper products.

14. The process of claim 13 wherein the substrate is currency paper.

15. The process of claim 1 wherein the curing in step d) is effected in the presence of photoinitiator for the curing of said resin employed.

16. The process of claim 1 wherein said solid, radiation-curable resin has a softening point in the range of from 100° F. to 400° F.

17. The process of claim 1 wherein the information to be transferred comprises material selected from the group consisting of holographic images, diffractive gratings, high refractive index layers, solid, radiation-curable resin layers, clear coats, adhesive layers, decorative elements, metallic particles, metal surfaces, vacuum deposited metal layers, printed text, colors, lettering, pictures, and scenes.

18. The process of claim 1 wherein said information to be transferred comprises said layer comprising a solid, radiation-curable resin.

19. The process of claim 18 wherein said radiation is ultraviolet radiation or electron beam radiation.

20. The process of claim 18 wherein said radiation-curable resin comprises epoxy group functionality.

21. The process of claim 18 wherein said radiation-curable resin comprises vinyl group functionality.

22. The process of claim 20 wherein the conditions of contacting in step c) to transfer said information include a temperature of between 100° and 400° F.

23. The process of claim 20 which includes the additional step of providing, prior to performing the curing step d), textual material on said solid, radiation-curable resin layer at a location where the textual material will contact said substrate when step c) is performed.

24. The process of claim 20 wherein the carrier layer is polyester material.

25. The process of claim 20 wherein the polyester material is polyethylene terephthalate.

26. The process of claim 20 wherein the carrier is peelable away from the solid, radiation-curable resin.

27. A hot stamping foil which comprises
a) a carrier layer which may or may not be peelable away from said composite, attached directly, or indirectly through one or more layers, to
b) a layer comprising a solid, radiation-curable resin,
wherein said hot stamping foil comprises information desired to be transferred to a substrate.

28. The hot stamping foil of claim 27 wherein said resin is curable by ultraviolet radiation or electron beam radiation.

29. The hot stamping foil of claim 28 wherein said radiation-curable resin comprises epoxy group functionality.

30. The hot stamping foil of claim 28 wherein said radiation-curable resin comprises vinyl group functionality.

31. The hot stamping foil of claim 29 wherein the hot stamping foil comprises a release coat between the carrier and the information to be transferred.

32. The hot stamping foil of claim 31 wherein the hot stamping foil additionally comprises a clear coat attached to said carrier layer.

33. The hot stamping foil of claim 31 wherein the hot stamping foil additionally comprises a clear coat between said release coat and said information to be transferred.

34. The hot stamping foil of claim 33 wherein said information to be transferred is either attached to said clear coat or is part of said clear coat.

35. The hot stamping foil of claim 29 wherein the carrier layer is not peelable away from the information to be transferred after said solid, radiation-curable resin has been cured.

36. The hot stamping foil of claim 29 wherein the carrier layer is polyester material.

37. The hot stamping foil of claim 36 wherein the polyester material is polyethylene terephthalate.

38. The hot stamping foil of claim 27 wherein the information to be transferred comprises material selected from the group consisting of holographic images, diffractive gratings, high refractive index layers, solid, radiation-curable resins, clear coats, adhesive layers, decorative elements, metallic particles, metal surfaces, vacuum deposited metal layers, printed text, colors, lettering, pictures, and scenes.

39. A composite structure comprising textual material bonded to a substrate, said composite comprising
a) a carrier layer, which may or may not be peelable away from said composite, attached directly, or indirectly through one or more layers, to
b) a layer comprising a solid, radiation-cured resin bonded to
c) a substrate at an interface between said radiation-cured resin and said substrate wherein said resin at said interface carries reverse printed textual material visible through the radiation-cured resin and said carrier, if present.

40. The composite of claim 39 wherein said cured resin is derived from ultraviolet radiation or electron beam radiation.

41. The composite of claim 40 wherein said resin is derived from a resin comprising epoxy group functionality.

42. The composite of claim 40 wherein said resin is derived from a resin comprising vinyl group functionality.

43. The composite of claim 41 wherein the composite additionally comprises a release coat between the carrier and the radiation-cured resin.

44. The composite of claim 43 wherein the composite additionally comprises a clear coat attached to said carrier layer.

45. The composite of claim 43 wherein the composite additionally comprises a clear coat between said release coat and said radiation-cured resin.

46. The composite of claim 45 wherein said radiation-cured resin to be transferred is either attached to said clear coat or is part of said clear coat.

47. The composite of claim 46 wherein the carrier layer is peelable away from said composite.

48. The composite of claim 47 wherein the carrier layer is polyester material.

49. The composite of claim 48 wherein the polyester material is polyethylene terephthalate.

50. The composite of claim 39 wherein said resin is derived from a solid, radiation-curable resin having a softening point of between 100° F. and 400° F.

51. The composite of claim 50 wherein the substrate is selected from the group consisting of polyvinyl chloride, polyesters, and paper products.

52. The composite of claim 51 wherein the substrate is currency paper.

53. The composite of claim 39 wherein the information comprises a material selected from the group consisting of holographic images, diffractive gratings, high refractive index layers, solid, radiation-curable resin, clear coats, adhesive coats, decorative elements, metallic particles, metal surfaces, vacuum deposited metal layers, printed text, colors, lettering, pictures, and scenes.
